(19) United States
(12) Patent Application Publication
(10) Pub. No.: US 2022/0142143 A1
(43) Pub. Date: May 12, 2022

(54) Irrigation Pest Control

(71) Applicant: Allen Lynn Davidson, Allen, TX (US)

(72) Inventor: Allen Lynn Davidson, Allen, TX (US)

(21) Appl. No.: 17/094,224

(22) Filed: Nov. 10, 2020

(51) Int. Cl. A01M 7/00; G05B 19/042; A01G 25/16; A01G 25/02; A01C 23/04; A01C 23/00

(52) U.S. Cl. CPC A01M 7/0092; G05B 19/042; A01G 25/16; A01G 25/023; G05B 2219/2625; A01C 23/047; A01M 7/0032; A01C 23/007; A01C 23/042

(57) ABSTRACT

The present irrigation pest control system relates generally to the automated dispersal of pest control agents and other agricultural agents to lawns and agricultural areas. Users may program a desired schedule for the dispersal of various chemical agents at certain time periods and in specified volumes by automating the dispersal of chemical agents into the irrigation system. This automated system can function through the programming of a multi-port pinch chemigation valve that regulates the dispersal of about twelve (12) different chemical agents housed in a plurality of smart port cartridges in fluid communication with the multi-port pinch chemigation valve. The multi-port pinch chemigation valve eliminates redundancies by integrating the dispersal of pest control and other chemical agents with the normal irrigation process.

### CROSS-REFERENCE TO RELATED APPLICATIONS

This application claims the benefit of U.S. Provisional Application No. 62/933,503 filed on Nov. 10, 2019.

### TECHNICAL FIELD

The present invention relates to the process of integrating pest control and other chemical agents into conventional agricultural watering techniques using a plurality of smart port cartridges, a multi-port pinch chemigation valve and a programmable irrigation system.

### BACKGROUND

Today, lawn irrigation is generally limited to the regulation of watering cycles. A property owner must follow up with redundant irrigation cycles for dispersal of various other agents to their lawns or crops, such as fertilizers, pesticides, and herbicides. The redundancy of measuring, regulating, and applying these other agents can be time consuming and unnecessarily expensive. There is a need in the industry for an automated chemical dispersal system that simultaneously reduces redundancies in current irrigation management by integrating multi-agent dispersal with traditional means for watering.

### OBJECTS OF THE INVENTION

A primary object of the present invention is to automate dispersal of pest control chemicals into an irrigation system.

It is another object of the pest control system to automate chemical application to combat pest infestations using a programmable delivery schedule.

It is another object of the pest control system to eliminate additional steps currently required for dispersing chemical agents by simultaneously integrating numerous pest control agents and other agricultural agents.

It is another object of the pest control system to automate chemical dispersal employing a plurality of smart port cartridges that can discern chemical agents.

It is another object of the pest control system to automate the infusion of chemical agents into an irrigation system by drawing from the smart port cartridges with respective chemical agents using a multi-port pinch chemigation valve.

### SUMMARY OF THE INVENTION

The present invention generally discloses an automated system for the regulated dispersal of various chemical agents in conjunction with standard irrigation systems. The programmable system achieves this dual application by regulating a multi-port pinch chemigation valve used for infusing chemical agents into general irrigation mechanics, preventing backflow, measuring water pressure and integrating watering management on a zone-by-zone basis.

In one embodiment of the programmable system, an A.I. interface wirelessly communicates an “upcoming treatment alert” to the registered owner of the system.

In one embodiment, the programmable system regulates a multi-port pinch chemigation valve that provides back pressure and regulated integration of desired chemical agents into the main water supply using AI-driven technology. In one embodiment, the multi-port pinch chemigation valve controls about thirteen (13) different smart port cartridges housing various chemical agents, such as fertilizer, fungicide, pesticide, herbicide, etc. This novel chemical agent regulation system adapts to climate conditions, vegetation feedback, and can be programmed to disperse zone-specific chemical agents. The present invention provides a new and improved AI-driven programmable system for regulating chemical agent dispersal by agent type that can be integrated with a traditional irrigation system.

Other features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific processes disclosed herein. The description of a process by a numeral in a drawing is applicable to the description of that process step shown by that same numeral in any subsequent drawing herein.

FIG. 1 shows a wall-mounted touch-screen monitor used for personalizing and programming the irrigation system, the plurality of smart cartridges and the multi-port pinch chemigation valve;

FIG. 2 shows a front perspective of the cabinet unit for housing smart port cartridges;

FIG. 3 shows the multi-port pinch chemigation valve and a plurality of smart port cartridges housed within the cabinet unit;

FIG. 4 shows a coronal view of the cabinet unit with the smart port cartridges and the multi-port pinch chemigation valve;

FIG. 5 shows a layered view of the multi-port pinch chemigation valve;

FIG. 6 shows a side view of the multi-port pinch chemigation valve;

FIG. 7 shows an underside view of the multi-port pinch chemigation valve's mechanical pistons; and

FIG. 8 shows a coronal view of the outer tubing attached to the top of multi-port pinch chemigation valve.

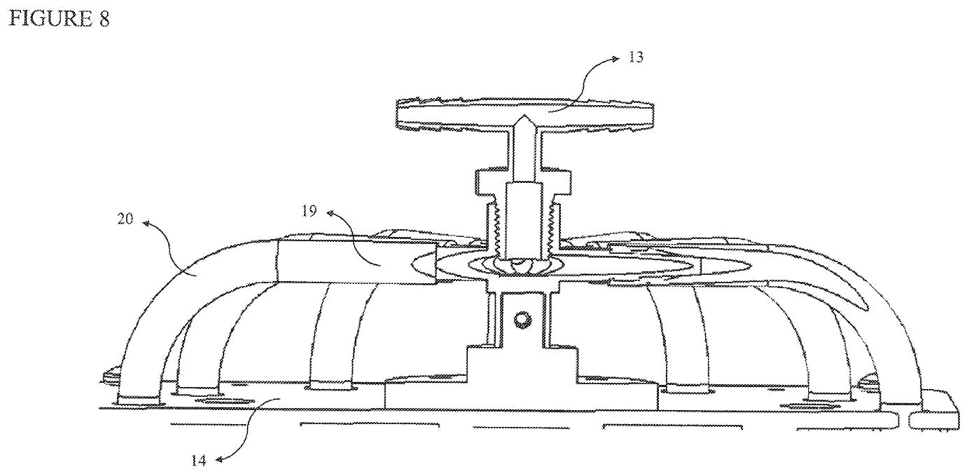

### SPECIFICATION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The disclosed embodiment includes multi-port pinch chemigation valve (“MPPCV”) 7 for infusing chemical agents into traditional irrigation systems using smart port cartridges. In one embodiment the MPPCV regulates the release of one or more smart port cartridges housing various chemical agents like pesticide, fertilizer, or herbicide. The plurality of smart port cartridges employ machine readable internal sensors to discern the particular chemical agent stored in each respective cartridge so that the programmable System can determine which cartridge to draw from for a particular zone associated with a particular cycle. This novel machinery not yet present in the field helps increase efficiency and decrease costs associated with lawn and agricultural maintenance.

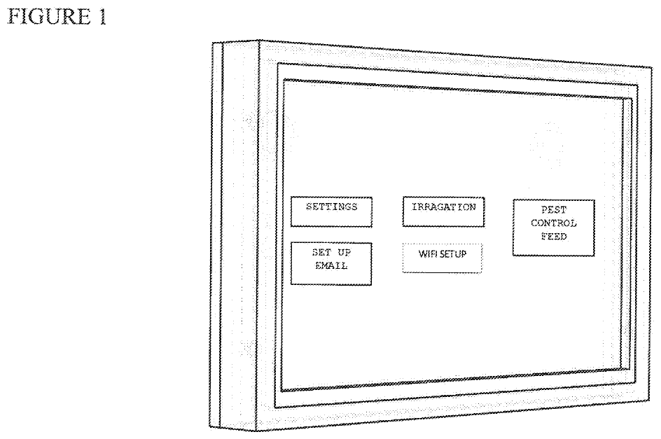

Referring to FIG. 1, in one embodiment, the MPPCV is regulated by an artificial intelligence (“AI”) on at least one central processing until for driving the water usage and chemical dispersion monitoring system using smart port cartridges and for individually controlling the pumps and for individually controlling the solenoids to the irrigation and sprinkler heads (the “System”). The System monitors and regulates flow measurement, frequency of application based on current and future weather conditions, field zones, vegetation specific watering, ongoing watering analysis and water supply PSI. In one embodiment, a user pre-programs personal information into the System using secured wall-mounted touchscreen 1C. The system can transmit an “upcoming treatment alert” to the pre-programmed user through at least wireless means. The pre-programmed user then accepts or rejects the alert. In another embodiment, the pre-programmed user can personally schedule treatment plans for defined agricultural zones at least by treatment type. In yet another one embodiment, the System approves the upcoming programmable treatment based on at least current and upcoming weather conditions by treatment type.

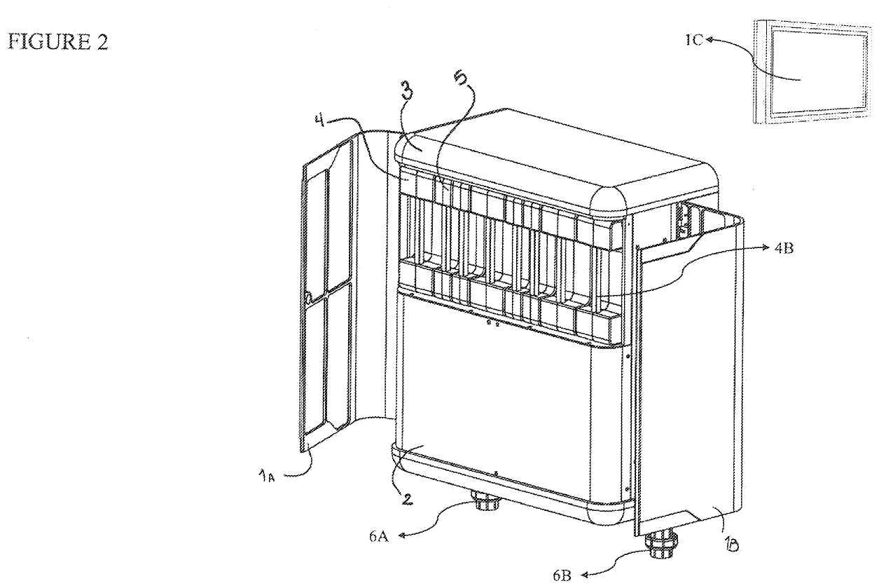

Referring to FIG. 2, in one embodiment, MPPCV is housed in a cabinet unit, comprising left door 1a held shut by a magnet, right door 1b, and cabinet component enclosure 2 to provide a secure door unlock operation and to block access to the working mechanics of the MPPCV. In one embodiment, touchscreen control panel 1C electronically communicates with MPPCV housed in the cabinet unit. The cabinet unit further comprises cabinet electronic enclosure 3 for housing electronics that lock, calculate, run, and power the System. In another embodiment, the cabinet unit is in fluid communication with the irrigation system through input cabinet pump 6A and output cabinet pump 6B. It yet another embodiment, the cabinet unit contains a plurality of small smart port cartridges 4 and large smart port cartridges 5 for housing chemical agents, such as pesticides and herbicides. In one embodiment, all smart cartridges are housed in a single cabinet enclosure.

The System employs a visual identification means such as labels and scannable barcodes to identify which smart port cartridge 4 and 5 needs replacement or insertion. In one embodiment, the plurality of smart port cartridges 4 and 5 may be slidably removed on guard rails for cleaning and refilling by pulling on attached handles 4B. In one embodiment, smart port cartridges 4 and 5 employ internal sensors in communication with the System to identify the chemical agent within that cartridge. This identification permits the System to determine which smart port cartridge 4 and 5 to draw from so that the respective chemical agent is subsequently infused into the main water line. In another embodiment, failure to properly insert smart port cartridges 4 and 5 results in a System “alert,” similar to the “upcoming treatment alert,” which prohibits smart port cartridges 4 and 5 from resuming normal operation until proper insertion. In another embodiment, the cabinet unit further comprises two hose clamps 12, each one containing six (6) clamps used to organize arrangement of the corresponding feed lines.

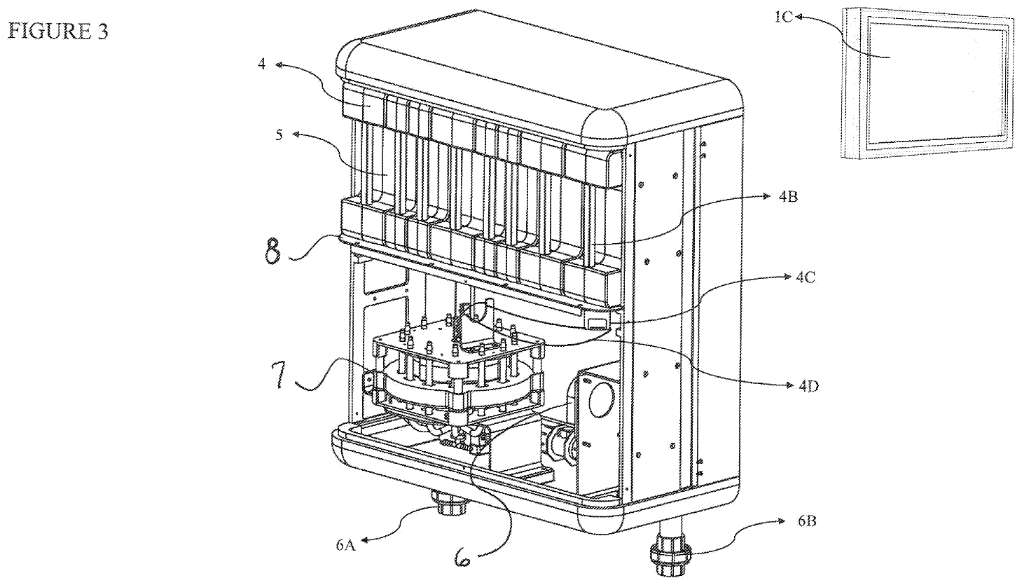

Referring to FIG. 3, the chemical agents housed in the plurality of small smart port cartridges 4 and large smart port cartridges 5 are in fluid communication with MPPCV 7 through flexible feed supply hose 4D that runs from the bottom of the plurality of smart port cartridges 4 and 5 to MPPCV 7 housed in the cabinet unit for controlled dispersal. In one embodiment, the plurality of smart port cartridges 4 and 5 each contain a float switch for detecting when the chemical treatments are low. The float switch detects a low volume of chemical agent and sends a signal via a low voltage wiring to control panel 1C whereafter control panel 1C alerts a user through email pre-programmed by control panel 1C.

In one embodiment, the cabinet unit employs cartridge rack 8 to divide small smart port cartridges 4 and large smart port cartridges 5. In another embodiment, control panel 1C is in electronic communication with MPPCV 7 and with a plurality of metal and plastic micro solenoid valves 4C. Once MPPCV 7 is turned on, an electrical signal is transmitted to micro solenoid valves 4C on the underside of smart port cartridges 4 and 5. Upon receiving the electrical signal, micro solenoid valves 4C open and the desired chemical agent from corresponding smart port cartridges 4 and 5 is siphoned through flow regulator 4D that is in fluid communication with MPPCV 7.

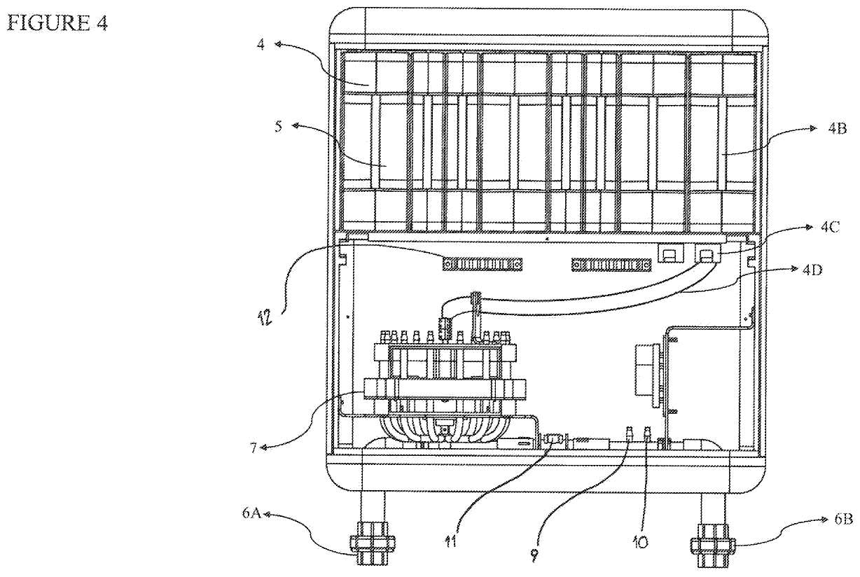

Referring to FIG. 4, in one embodiment, the System initiates a treatment process through electronic communication with MPPCV 7, which receives an activation signal from the System, thereby activating MPPCV 7. Once MPPCV 7 is activated, the System measures water flow and pressure to determine conditions within the appropriate parameters for the scheduled treatment. In one embodiment the System opens flow regulator 4D which provides fluid communication between smart port cartridges 4 and 5 and MPPCV 7.

In another embodiment, the cabinet unit contains inflow valve 9 for diverting water from the main water line according to speed cycle, zone vegetation and flow characteristics programmed in the System for the particular treatment plan. Cabinet pump 6A positively flows the chemical agents through MPPCV 7 and outflow valve 10 to infuse the main water irrigation line with chemical agents already controllably integrated into the positively flowing water by MPPCV 7. In one embodiment, the cabinet unit includes flow meter 11 for dynamic feedback control pertaining to valve regulation speed data, which is later used to regulate the flow of chemical agents back into the water line through MPPCV 7 and back into the System by cabinet pump 6B. Once MPPCV 7 completes infusion of the chemical agent assigned to the treatment plan, cabinet pump 9 ceases operation and permits regular water flow through the normal irrigation system path.

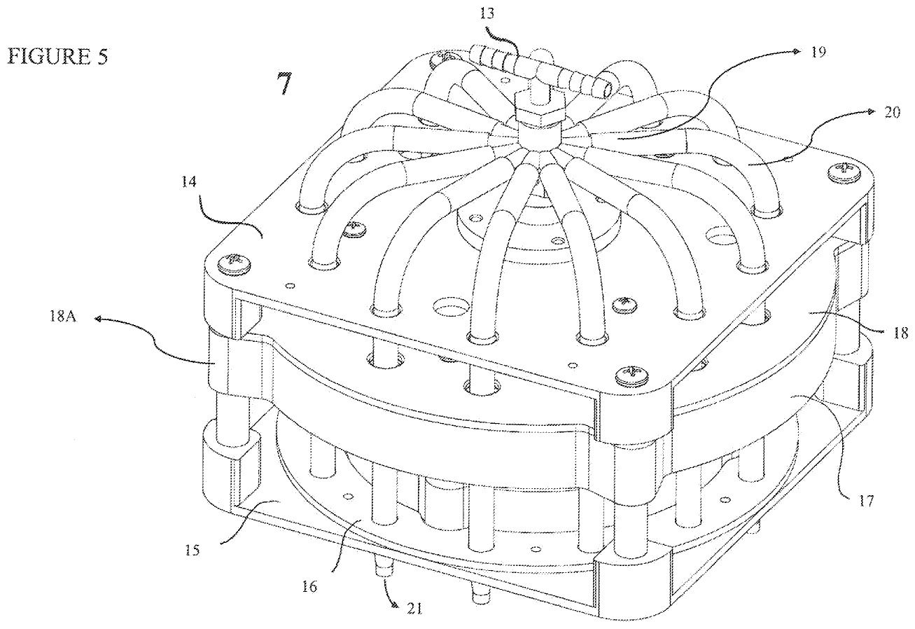

Referring to FIG. 5, in one embodiment MPPCV 7 receives desired chemical agents from smart port cartridges 4 and 5 via flow regulator 41), which is in fluid communication with MPPCV 7 by mechanically coupled plastic barbed hose fitting 13. In one embodiment, MPPCV 7 drives the pumping of twelve (12) different chemical agents. Although there are thirteen (13) valves in MPPCV 7, one of the thirteen (13) valves is not connected to MPPCV 7 and is only used for pressure sensory feedback. In one embodiment, MPPCV 7 contains selector compression cup opposite 14 and selector compression cup 15, each one mechanically coupled to the other by pressure wall 18A to ensure structural integrity of MPPCV 7. Selector retention plate 16 is horizontally flush against selector compression cup 15 and is substantially perpendicular to plastic barbed hose fitting 13. Selector retention plate 16 is mechanically coupled to downward barbed fitting 21 such that MPPCV 7 maintains structural integrity and does not twist on itself when the internal piece rotates during activation.

In one embodiment MPPCV 7 contains horizontally positioned selector piston 17 for housing the piston assembly. Flush to the top side of selector piston 17 is selector piston retention plate 18, which is mechanically coupled to substantially perpendicular threaded spacer 18A used to keep the various piston assemblies from spiraling in an outward progression during use.

On the uppermost side of MPPCV 7 is outwardly projecting selector multi-port manifold 19 for feeding the various flexible tubing units into a single outlet so that the various chemical agents can exit through a single port. Connected to selector multi-port manifold 19 are various downward-flowing selector housing tubes 20. In one embodiment, selector housing tubes 20 are in fluid communication with smart port cartridges 4 and 5 through flexible feed supply hose 4D.

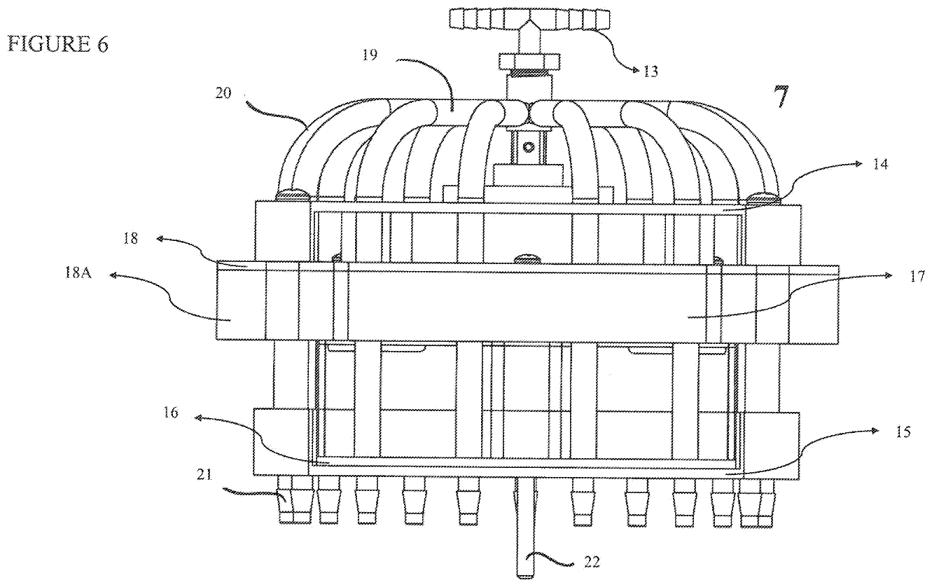

Referring to FIG. 6, in one embodiment, downwardly projecting selector double barbed fitting 21 comprises a double barbed fitting meant to connect a tube from each side and for a plurality of chemical agents to pass through MPPCV 7. Medial to selector double barbed fitting 21 is selector main cam 22 which mechanically connects selector piston housing 17 to a motor for turning the body of MPPCV 7. Selector main cam 22 contiguously applies mechanical force on the pistons so that the fluid tubes remain closed when MPPCV 7 is dormant.

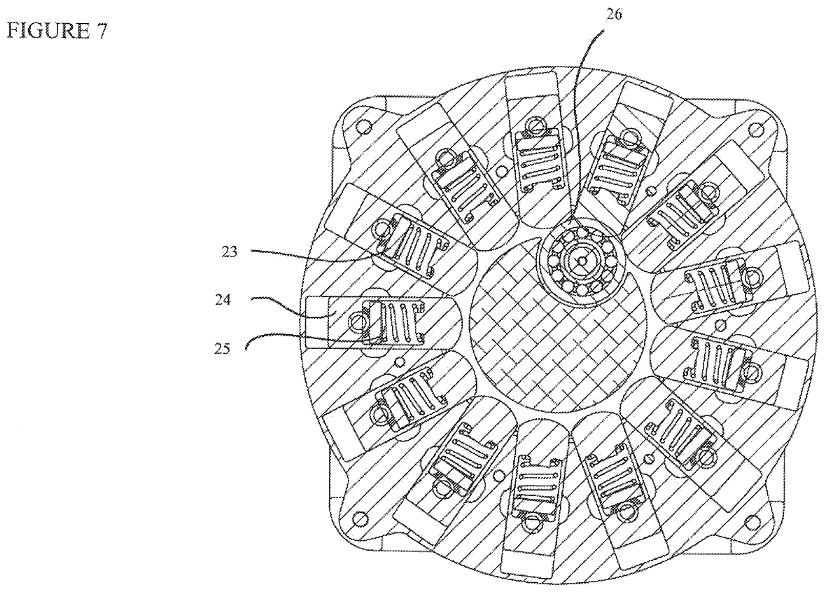

Referring to FIG. 7, MPPCV 7 comprises stationary tube compression wall 23 for pressing a piston against the tube penetrating the wall. In a dormant state or when a particular chemical agent for that tubing line is paused, the corresponding line is pinched such that the tube is kept closed and the chemical agent cannot flow through the respective line. In one embodiment, the underside of MPPCV 7 contains 13 outwardly-projecting selector pistons 24. Outwardly-projecting selector pistons 24 house a stationary tube compression wall, a selector piston spring, and an opening to permit a tube to penetrate selector piston 24. Within said opening for the tube is a Selector CAM Roller Bearing used to press against the rounded side to remove pressure from Stationary Tube Compression Wall 23 so that the corresponding chemical agent can run through that tube.

Selector piston 24 further houses selector piston spring 25, which pinches the tube passing through selector piston 24, thereby preventing the chemical agent in selector housing tube 20 from passing through. When an external pump is closed off, MPPCV 7 rotates the CAM to an alternative desired chemical port for infusion of the selected chemical agent into the main water line. This movement is guided by the selector main CAM which gently applies force to release the pinch pressure on each selector housing tube 20 such that the chemical agent can pass through. In one embodiment, the bottom of MPPCV 7 houses selector CAM roller bearing 26. Once MPPCV 7 completes controlled infusion of the chemical agents into the main water line, selector CAM roller bearing 26 mechanically connects to the selector main CAM and rolls across rounded selector pistons 24 to position the clean in place (“CIP”) port, which is used to clear the pump lines of any previous chemical/dosage. Once the lines have been cleaned using the CIP port, the System activates selector main cam 22 for contiguous application of mechanical force, essentially inactivating MPPCV 7. Once main cam 22 is activated, the System verifies MPPCV 7 is dormant.

In another embodiment, a circuit board will be maintained in MPPCV 7. MPPCV 7 circuit board will employ position sensors and inform the circuit board located in cabinet electronic enclosure 3 which smart port cartridges 4 and 5 to siphon. In another embodiment, each smart port cartridge contains an RFID indicator or other cartridge detecting technology read by the System informing the System of the content and quantity of each smart port cartridge. In another embodiment, the System can optically scan each smart port cartridge to determine remaining quantity of chemicals/dosage. In another embodiment, smart port cartridges can be inserted into the System in any order and without regard to content and quantity as the System will adjust based on said RFID indicator or other cartridge detecting technology. A System programmable controller is capable of reading the content and quantity of the smart port cartridge, including a low content or empty condition, and can notify a user or administrator of same either on the cartridge itself or remotely. System dispersion from the smart port, after mixing with a main water line, can occur either through a spray head, drip line, or other commonly used means of watering lawns through irrigation.

In another embodiment, the MPPCV 7 and its smart port cartridges therein are agnostic in selection, meaning that smart port cartridges can be inserted in any order and configuration and the System controller (e.g. electronic circuit board and programmable microprocessor) will be capable of identifying the smart port cartridge content for irrigation and/or treatment. This benefit of being port agnostic is that no error can be made when using pesticides or fertilizer, etc, within the same unit.

Preferred embodiments of this invention are described herein, including the best mode known to the inventors for carrying out the invention. It should be understood that the illustrated embodiments are exemplary only and should not be taken as limiting the scope of the invention.

The foregoing description comprises illustrative embodiments of the present invention. Having thus described exemplary embodiments of the present invention, it should be noted by those skilled in the art that the within disclosures are exemplary only, and that various other alternatives, adaptions, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings in the foregoing descriptions. Although specific terms may be employed herein, they are used only in a generic and descriptive sense and not for purposes of limitation. Accordingly, the present invention is not limited to the specific embodiments illustrated herein.

What is claimed:

1. A computer regulated irrigation system utilizing a main water line with a plurality of zone lines, each zone line having dispersion outlets, a valve coupled to each zone line operatively coupled to the main water supply line, a solenoid coupled to each valve, and a processor for controlling said valves, the computer regulated irrigation system comprising:
A multi-port pinch chemigation valve operatively connecting to a plurality of smart port cartridges;
A programmable controller for detecting the content-type of at least one smart port cartridge, and selecting at least one smart port cartridge for infusing the contents of said smart port cartridge into the main water line through said multi-port pinch chemigation valve;
Said multi-port pinch chemigation valve operatively connecting each smart port cartridge line to each zone line for permitting and obstructing, as applicable, the passage of said smart port cartridge contents through each zone line and into said dispersion outlets;
At lease one pump for moving water through the multi-port pinch chemigation valve and smart port cartridges.

2. The apparatus of claim 1, wherein said dispersion outlet is selected from the group consisting of spray head, drip line and combinations thereof.

3. The apparatus of claim 1, wherein said programmable controller identifies that a smart port cartridge is running low on contents or is otherwise empty, and remotely notifies an administrator of same.

4. A smart port cartridge irrigation/chemical injection system for automatically irrigating individual zones and for applying liquid chemicals chosen from the class of liquid chemicals including fertilizer chemicals and pest control chemicals concentrated in smart port cartridges housed together in a centralized cabinet enclosure to the individual zones, the smart port cartridge irrigation/chemical injection system comprising:
a main water supply line having an input and an output, the input of the main water supply line adapted to be coupled to a supply of water for irrigation;
one or more dispersion outlets operatively coupled to the output of the main water supply line and coupled to the zone lines;
a valve operatively coupling each zone line to the main water supply line, each valve adapted to be switched between an open orientation for permitting the passage of chemicals and a closed orientation for precluding the passage of chemicals;
a multi-port manifold of downward-flowing selector housing tubes wherein the selector housing tubes are in fluid communication with at least one smart port cartridge through at least one flexible feed supply hose;
a solenoid operative coupled to each valve for switching the valves as the multi-port manifold rotates through infusion of said concentrated smart port cartridges liquid chemicals;
at least one pump operatively coupled to said multi-port manifold and at least one smart port cartridge;
a first programmable irrigation electronic processor for individually controlling the solenoids with the valves for irrigation purposes; and
a second electronic circuit board and programmable microprocessor for individually controlling at least one pump and for individually controlling smart port cartridges and multi-port manifold.
